(19) United States
(12) Patent Application Publication
(10) Pub. No.: US 2009/0111086 A1
(43) Pub. Date: Apr. 30, 2009

(54) KIT FOR FACILE DEPOSITION AND EVALUATION OF SEMICONDUCTOR DEVICES

(76) Inventors: Howard E. Katz, Owings Mills, MD (US); Jonah D. Erlebacher, Chevy Chase, MD (US)

Correspondence Address: VENABLE LLP, P.O. BOX 34385, WASHINGTON, DC, 20043-9998, US

(21) Appl. No.: 12/254,529

(22) Filed: Oct. 20, 2008

Related U.S. Application Data
(60) Provisional application No. 60/999,478, filed on Oct. 18, 2007.

(51) Int. Cl. G09B 25/00

(52) U.S. Cl. 434/365

(57) ABSTRACT

An emulsion includes a substantially continuous liquid medium, and a plurality of droplet structures dispersed within the substantially continuous liquid medium. Each droplet structure of the plurality of droplet structures includes an outer droplet of a first liquid having an outer surface; an inner droplet of a second liquid having an inner surface contained within the outer surface of the outer droplet of the first liquid, the second liquid being immiscible in the first liquid, wherein the inner and outer droplets have a boundary surface region therebetween; an outer layer of block copolymers disposed on the outer surface of the outer droplet; and an inner layer of block copolymers disposed on the inner surface of the inner droplet. The block copolymers include a hydrophilic polymer block and a hydrophobic polymer block that act in combination to stabilize the droplet structure, and the first liquid is immiscible in the substantially continuous liquid medium.

### CROSS-REFERENCE TO RELATED APPLICATION

This application claims priority to U.S. Provisional Application No. 60/999,478 filed Oct. 18, 2007, the entire contents of which are hereby incorporated by reference.

### BACKGROUND

1. Field of Invention

The present invention relates to educational kits, and more particularly to educational kits for making and characterizing electronic components and devices.

2. Discussion of Related Art

There is a growing need for high school, community college, and undergraduate curricula that stimulate a drive for scientific investigation among science students. A recent article (D. I. Hanauer, D. Jacobs-Sera, M. L. Pedulla, S. G. Cresawn, R. W. Hendrx, and G. F. Hatfull, “Teaching scientific inquiry,” Science 314, 1880 (2006)) described a tension within science classes—one needs to convince students of the correctness of established knowledge and yet also offer a model for scientific inquiry as practiced by professional researchers. The former requirement tends dominate traditional curricula because it is compatible with standardized testing, and is easier to meet when there are deficient facilities, time constraints, etc. To overcome this tension and help address the latter requirement, the authors described a research exercise they developed involving bacteriophage growth and genome sequencing that was suitable for undergraduate- and high school-level students. They used methods standard enough for facile replication by young students but also addressed the inquiry aspect, with outcomes unique enough to impart a research flavor—even to the extent that, with a bit of extra effort, the exercises could lead to publications. This program was extendable enough that undergraduate researchers at the University of Pittsburgh interacted successfully with high school participants as collaborators.

The above account concerns a life sciences module, but the need may be even greater in the physical sciences. Teaching chemistry and physics exclusively as theory, or as theory accompanied by trivial experiments with obvious outcomes, promulgates these fields as stale, fact-based subjects in which most of the interesting results have been worked out long ago. In this environment, physical science seems harder than other subjects to grasp by any but the most mathematically adept. Few students are inclined to make the effort to gain full command of the subject matter, and those that make this effort fail to appreciate the give and take between hypothesis and testing, and between conceptualization and realization. Bluntly stated, this situation puts the scientific method in danger of being forgotten by the next generation! If this trend continues, our nation will be deprived of its future inventors and innovators, and a scientifically literate workforce in supporting professions and trades.

The teaching of introductory electronics and electronic materials is particularly lacking in experiential opportunities. Many high school and college-level physics courses are mechanics-based and the electronics portions of these courses, even if there is a laboratory component, often cover little more than Ohm's Law and the measurement of resistances of wires and commercial standards. Hands-on appreciation for simple electronic devices such as transistors, in which current between two electrodes, the “source” and “drain,” is mediated by the voltage placed at a third electrode, the “gate”, and diodes, which preferentially conduct in one polarity, is not developed until more advanced courses. There is thus a need for improved educational kits for the physical sciences.

### SUMMARY

An educational kit according to some embodiments of the current invention include electronic materials for the construction of an electronic component by a student in a classroom, and an instruction packet that provides instructions for the construction of the electronic component by the student in the classroom using the electronic materials. The electronic materials for the construction of the electronic component are suitable for use by the student in the classroom without safety equipment and the instruction packet requires no more than common classroom equipment for the construction of the electronic component.

A method of teaching according to some embodiments of the current invention include providing a student with an educational kit that provides electronic materials and an instruction packet to construct at least one electronic component from the materials provided in the kit according to instructions provided in the instruction packet; requiring the student to construct the at least one electronic component, to perform device-characterization tests on the at least one electronic component, and to prepare a written report of results of the constructing and characterization of the at least one electronic component; and evaluating the written report. The electronic materials for the construction of the at least one electronic component are suitable for use by the student in the classroom without safety equipment and the instruction packet requires no more than common classroom equipment for the construction of the electronic component.

### BRIEF DESCRIPTION OF THE DRAWINGS

Additional features of this invention are provided in the following detailed description of various embodiments of the invention with reference to the drawings. Furthermore, the above-discussed and other attendant advantages of the present invention will become better understood by reference to the detailed description when taken in conjunction with the accompanying drawings, in which:

FIG. 1A is a schematic illustration of a field effect transistor that can be constructed as an electronic component according to an embodiment of the current invention;

FIG. 1B shows device-characterization data obtained for a field effect transistor constructed as an electronic component according to an embodiment of the current invention,

FIG. 1C is a schematic illustration of a diode that can be constructed as an electronic component according to an embodiment of the current invention;

FIG. 2 shows molecular structures of some semiconductors that can be included as electronic materials in kits according to some embodiments of the current invention;

FIG. 3 shows a student-generated plot of drain currents versus drain voltages at a series of gated voltages (+20 to −100 V) for PQT12 on Si/SiO₂ according to an embodiment of the current invention (Though gate leakage distorts the curves, the field effect and saturation are clearly observed.);

FIG. 4 shows behavior of a PQT12 transistor made on anodized alumina gate with carbon ink electrodes according to an embodiment of the current invention (The channel was ca. 2 mm×1 mm. A field effect on the source-drain current-voltage behavior is apparent as the gate is biased to −10 V.);

FIG. 5 shows examples of some polymers that can be used as electronic materials in kits according to some embodiments of the current invention (Subunits Z are intended as comonomers, along with the bithienyl subunit in the parent PQT12. Hydroxyalkyl side chains will also be appended.); and

FIG. 6 illustrates a lateral organic diode with a self-aligned pn junction that was can be constructed with a kit according to an embodiment of the current invention, along with the corresponding device characterization (TIPS-pentacene is deposited from solution between the fluorinated surfaces of sublimed F15 and a fluoroacrylate insulating polymer).

### DETAILED DESCRIPTION OF VARIOUS EMBODIMENTS

All references cited anywhere in this specification are incorporated herein by reference.

Some embodiments off the current invention are directed to educational kits and methods for a new kind of electronics materials laboratory course, in which students not only test electronic devices such as transistors, but also build them from the constituent materials. The kits can provide laboratory modules and integrate them into undergraduate Materials Science curricula. Course modules based on kits and methods according to some embodiments of the current invention can also be valuable enhancements to physics and chemistry courses at the high school level. The kits and methods can be pedagogical about the major classes of materials and how to make and process them, and yet be simple enough to transfer to curricula which assume minimal institutional experience with device materials. The kits and methods according to some embodiments of the current invention can teach both theoretical and practical skills, and give students broader appreciation for current areas of transformative materials science research.

An educational kit according to some embodiments of the current invention comprises electronic materials for the construction of an electronic component by a student in a classroom, and an instruction packet that provides instructions for the construction of the electronic component by the student in the classroom using the electronic materials. The electronic materials for the construction of the electronic component are suitable for use by the student in the classroom without safety equipment and the instruction packet requires no more than common classroom equipment for the construction of the electronic component.

The term “electronic component” includes capacitors, diodes and transistors, for example. Such devices can also be photoactive in some cases. The term “electronic device” can refer to an electronic component, but may also refer to more complex structure which could include numerous electronic components and electronic circuits. For example, electronic circuits that contain more than one transistor or diode or a combination of the two can be included. However, the invention is not limited to only this example. The term “classroom” is intended to include the typical high school, junior college, undergraduate classroom and teaching laboratories in which clean room conditions are not required and in which special safety clothing is not needed. It is intended to include cases in which electrical components are made by hand and/or with simple equipment such as paint brushes, hand-held stencils, printers, hand-held stamps, spin-coaters and other inexpensive equipment that can be used in a typical classroom such as dry transferable films from masters. For example, expensive and complex equipment such as photolithography machines (“steppers”), sputterers, vacuum thermal deposition equipment, high speed or programmable spin coaters and similar equipment are not required.

The instruction packet can further provide instructions for measuring a physical property of said electronic component such as measuring characteristics of transistors, diodes, etc that have been constructed by the student with the kit.

The electronic materials in the kits can include one or more electrical conductor, one or more electrical insulator and/or one or more semiconductor. For example, the electronic materials of the kit can include aluminum oxide as a dielectric material for use in constructing an electronic component. The dielectric material can be hydrophobic aluminum oxide that has a passivation layer in some embodiments. The electronic component that can be constructed and characterized with a kit according to some embodiments of the current invention can include a capacitor, a transistor and/or a diode. Various circuits and more complex devices can be built up with the components according to some embodiments of the current invention. In some embodiments, the electronic materials can include solution-processable semiconductors and/or conductors.

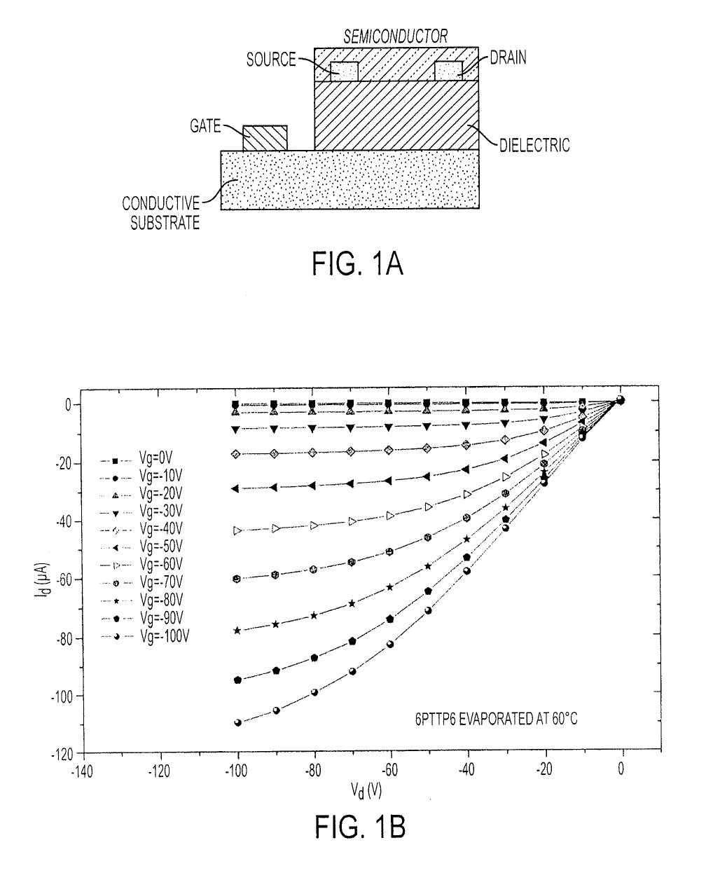

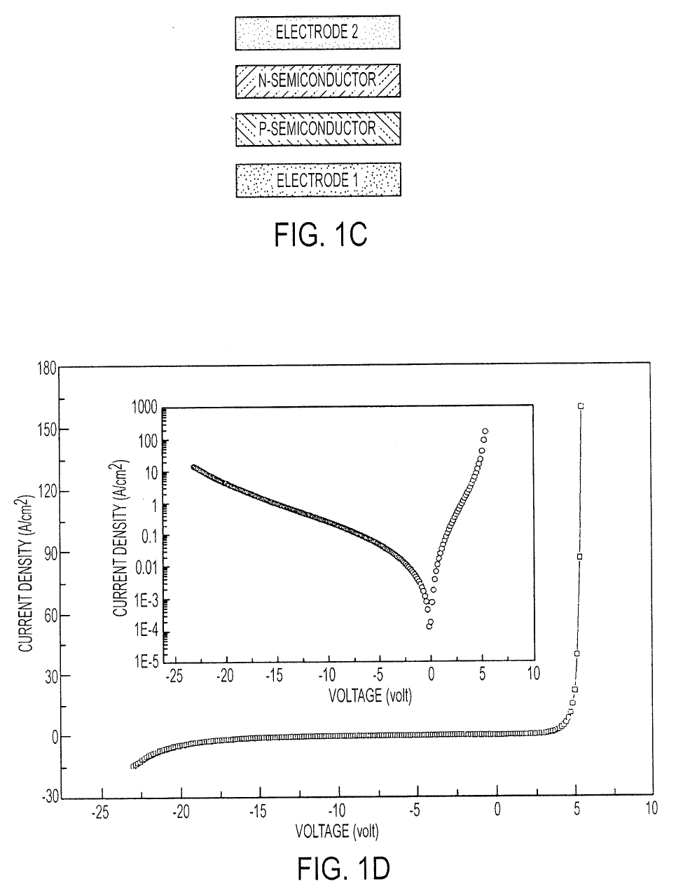

FIGS. 1A and 1C are schematic illustrations of active device structures that can be included in educational kits according to some embodiments of the current invention. A field-effect transistor (FIG. 1A) consists of a semiconductor layer separated from a gate conductor by an insulator, the gate dielectric in this example. When current through the semiconductor is plotted versus the voltage between source and drain (FIG. 1B), increasing conductivities are obtained as the gate voltage increases. When drain voltage exceeds gate voltage, further increases in the drain voltage are ineffective for increasing the current, and the transistor “saturates”. A diode (FIG. 1C) consists of multiple layers with different charge carrier energies. Current flows much more easily in one direction than the other, as illustrated by the sample plot in FIG. 1D.

Transistors and diodes help illustrate some aspects of the fundamental concepts of resistors and capacitors, which are characterized by their opposition to the flow of current and the number of charge carriers they can accumulate at given applied voltages, respectively. In the experience of the current inventors, spanning high school, four-year college, and research university teaching, basic knowledge such as “how much voltage or current is a lot” or “what magnitude of capacitance is reasonable” are not being learned by our students. Ironically, the most hands-on electronics courses are found in “industrial arts” departments, where students with supposedly lower academic inclination are gaining valuable experience assembling and testing electronic circuits. Their feel for how electricity works is likely far superior to that of their classmates on the nominally more elite scientific tracks.

There are few accounts in the science education literature of accessible device fabrication/measurement activities beyond simple resistors. One exception (M. Dawber, I. Furan, and J. F. Scott, “A classroom experiment to demonstrate ferroelectric hysteresis,” American Journal Of Physics 71, 819 (2003)), recommended for undergraduate laboratories, is a simple and ingenious experiment to observe ferroelectricity in a handmade potassium nitrate capacitor in which a KNO₃ film is cast and baked, and an oscilloscope/function generator at 1 kHz is used to demonstrate the ferroelectric hysteresis. A more typical example comes from Ohio State University, which has introduced an admirable upper-level course in photonics that includes the handling of liquid crystals, optical fibers, and quantum wells (B. L. Anderson, I. J. Pelz, S. A. Ringel; B. D. Clymer, and S. A. Collins, “Photonics laboratory with emphasis on technical diversity,” IEEE Transactions On Education 41, 194 (1998)). The emphasis is not on electronics or electronic materials, and we presume a sophisticated laboratory setup is required. Other examples of laboratory classes involving more sophisticated apparatus are abundant: In one, a bipolar transistor analysis uses prefabricated devices and an LCR meter (C. H. Phang, Y. T. Yeow, R. A. Barham, and P. J. Allen, “Measurement of hybrid-pi equivalent circuit parameters of bipolar junction transistors in undergraduate laboratories,” IEEE Transactions On Education 40,213 (1997)). In another, a transistor reliability investigation aimed at beginning graduate students uses devices made by the students in a silicon fabrication facility, and employs the versatile but expensive Agilent 4156 semiconductor parameter analyzer for testing (I. S. Yuan and H. Yang, “Integrating semiconductor device characterization and reliability into electrical engineering education,” International Journal of Electrical Engineering Education 43. In some cases, simpler materials, e.g. light -emitting diodes made from organic semiconductors, that might be used to demonstrate electronic materials functionality are being considered in undergraduate laboratories (D. Braun, K. Kingsbury, and L. Vanasupa, “Semiconducting polymers for multidisciplinary education,” MRS Symposium Spring, HH 8.4 (2000); K. Kingsbur, D. Braun, and L. Vanasupa, “Semiconducting polymers for multidisciplinary education,” Abstracts Of Papers Of The American Chemical Society 221, U 125 (2001)), but these cases are exceptions.

A few additional published descriptions of curricula and specific experiments related to electronic materials and devices exist. Most of these use various strategies to analyze commercially purchased devices, including diodes (S. M. Condren, G. C. Lisensky, A. B. Ells, K. J. Nordell, T. F. Kuech, and S. A. Stockman, “LEDs: New lamps for old and a paradigm for ongoing curriculum modernization,” Journal Of Chemical Education 78, 1033 (2001); D. A. Johnson, “Demonstrating The Light-Emitting Diode,” American Journal of Physics 63, 761 (1995)), capacitors (F. X. Hart, “Computer-based experiments to measure RC,” The Physics Teacher 38, 176 (2000)), and multicomponent circuits (Kentucky and Connecticut State Departments of Education Curriculum Guides, 1992 and 1989, respectively). Others that did include device fabrication relied on significant photolithography, with its commensurate expense (D. Parent, E. Basham, Y. Dessouky, S. Gleixner, G. Young, and E. Allen, “Improvements to a microelectronic design and fabrication course,” IEEE Transactions On Education 48, 497 (2005); A. M. Christenson, G. W. Corder, T. C. DeVore, and B. H. Augustine, “A photolithography laboratory experiment for general chemistry students,” Journal of Chemical Education 80, 183 (2003); B. H. Augustine and T. C. DeVore, “A photolithography laboratory experiment for general chemistry students,” Abstracts of Papers of The American Chemical Society 220, U179 (2000)).

In short, curricula in physics, chemistry, and engineering courses are lacking in the types of materials considered, in opportunities to process materials underlying important technologies, and in the range of devices made from the materials. Semiconductors are not investigated in a manner that enables students to appreciate their activity. Insulators are used as shielding around conductors, but not as the key materials in capacitors. Store-bought components are tested only as “black boxes”, with no way to understand how the materials are integrated to make the component. Transistors and diodes, the key elements in microelectronics technology, are generally outside the curricula altogether, considered too difficult to understand and too sophisticated to fabricate. Not only are the students missing the most economically important aspect of electronics, an opportunity to relate science education to the silicon-based entertainment, communication, and computational gadgetry at the center of the young adult's world is being squandered.

Educational kits according to embodiments of the current invention can include a number of laboratory modules that will form the basis for an integrated, semester-long course involving the fabrication of electronic materials, processing them into the form in which they would be used as devices, testing the devices, and examining their synergy in circuits. In all of the modules presented, a combination of cutting-edge and traditional materials technologies can be addressed using only inexpensive, readily accessible equipment.

General features of modules in educational kits according to some embodiments of the current invention can include:
Use of all three major classes of electronic materials (metals, semiconductors, and insulators), to make electronic devices.
Use of simple, inexpensive equipment to electrochemically process metals to give them insulating dielectric film coatings. Fundamental materials principles that can be taught here include kinetics of diffusion and chemical reactions related to electronic materials processing.
Use of simple, inexpensive, soluble organic semiconductors integratable into transistors and diodes. Fundamental materials principles that can be taught here include crystallization and charge carrier transport.
Use of simple processing tools such as direct writing through stencils to make integrated devices. Students will learn about materials interactions, and real-life device fabrication.
Use of devices that can be tested at low enough voltages so that affordable test equipment, rather than professional-level analyzers, can be employed.

The modules can be developed based on laboratory experiments that have already been introduced in undergraduate classrooms and additionally carried out by high school students and teachers. From a performance standpoint, device geometries and electronic properties are defined and well-enough characterized that observable current and current changes are produced when devices are powered by inexpensive and safe batteries and power supplies. Materials to be used are assessed for chemical stability and comply with toxicity standards. Our semiconductor films and dielectric interfaces are reliable even when made by untrained investigators. Deposition and pattering methods are adapted for laboratories without access to expensive apparatuses.

Educational kits and methods according to some embodiments of the current invention can include the following modules.

Laboratory Modules

Ultimately, students will make and test a field-effect transistor, such as shown in FIG. 1A according to an embodiment of the current invention. Along the way they can pursue the following modules:

1. Module #1: Capacitance. Aluminum substrates will be anodized electrochemically. Students will learn how capacitance is affected by initial surface quality, how oxides may be formed electrochemically, and how capacitance is related to oxide thickness. Phosphonate coatings will be applied to control leakage, and tailor surface hydrophobicity/philicity.

2. Module #2: Electrowetting. The concept of charged dielectric interfaces will be dramatically demonstrated by controlling the contact angle of a deposited droplet via the charge deposited on the interface. The Lippman-Young equation will be explored. Students will learn the concepts of surface charge, wetting and contact angles, and how surface chemistry and structure can affect these properties.

3. Module #3: Patterned Deposition of Organic Conductors and Semiconductors. An introduction to the concept of patterned deposition will give students insights into modern device manufacture. Here, students will pattern electrodes and semiconductive regions “by-hand” through stencil masks and dry-transfer printing.

4. Module #4: Field-Effect Transistors. Students will pattern and test field-effect transistors. Skills from modules #1-#3 will be used to pattern devices over insulating dielectrics. Students will learn about characteristics of transistor action, including on/off voltages and field-effects on the source-drain current.

5. Module #5: Diodes. Students will create more complex three-dimensional patterned devices that include interfaces between n- and p-type organic semiconductors. These devices will exhibit diode action, and students will learn about rectification.

Each module can be designed to take approximately two weeks to do, easily allowing them to fit within a standard 13-week semester, with a bit of flexibility to expand one or more. However, general concepts of the current invention are not limited to the specific length of the course or modules.

One aspect of this program according to an embodiment of the current invention is that we are not out to discover new materials physics. All of the phenomena, materials, and techniques we describe can be conventionally known. An aspect of the current invention is to adapt these to the teaching environment so that they are safe and effective pedagogical tools, and not a “gee-whiz” result of dubious reproducibility.

Module #1. Capacitance.

According to an embodiment of the current invention, a reproducible gate dielectric, producible on a teaching laboratory scale is provided. The most typical gate dielectric used in organic semiconductors is silicon dioxide, usually grown as a thermal oxide on silicon wafers. Silicon wafers can be prohibitively expensive for teaching labs. An equally good, if not better, dielectric is aluminum oxide. A number of groups have used this material as a gate dielectric for organic electronics (C. Yang, K. Shin, S. Y. Yang, H. Jeon, D. Choi, D. S. Chung, and C. E. Park, “Low voltage organic transistors on a polymer substrate with an aluminum foil gate fabricated by a laminating and electropolishing process,” Applied Physics Letters 89 (2006); K. D. Kim and C. K. Song, “Low voltage pentacene thin film transistors employing a selfgrown metal-oxide as a gate dielectric,” Applied Physics Letters 88 (2006); L. A. Majewski, R. Schroeder, M. Voigt, and M. Grell, “High performance organic transistors on cheap, commercial substrates,” Journal of Physics D-Applied Physics 37, 3367 (2004); L. A. Majewski, M. Grell, S. D. Ogier, and J. Veres, “A novel gate insulator for flexible electronics,” Organic Electronics 4,27 (2003); P. F. Baude, D. A. Ender, M. A. Haase, T. W. Kelley, D. V. Muyres, and S. D. Theiss, “Pentacene-based radio-frequency identification circuitry,” Applied Physics Letters 82, 3964 (2003)), one of which involved electropolishing (Yang, 2006). It has long been known that aluminum oxide can be grown electrochemically on aluminum plate or aluminum foil (L. Young, Anodic Oxide Films (Academic Press, London and New York, 1961)). In fact, aluminum foil/aluminum oxide capacitors are very common, though the devices described in the organic electronics references of this paragraph employ relatively high-tech methods to produce complete devices.

Fundamentally, the capacitance of an oxide film is given by C=∉A/d, where ∉ is the dielectric constant of the material, A is the area, and d is the thickness. A typical “native oxide” on aluminum is approximately 2-3 nm thick, leading one to think that pure aluminum should be ideal. However, the oxide is not very dense, and prone to breakdown at even moderate voltages. This is why aluminum conducts electricity across contacts very well. Two strategies are used to alleviate this problem. Most recently, a passivating coating based on organic compounds with phosphonic acid headgroups have been used to fill pinholes (H. Klauk, U. Zschieschang, J. Pflaum, and M. Halik, “Ultralow power organic complementary circuits,” Nature 445, 745 (2007)); this effect increases capacitance by allowing the use of thinner oxides. They also allow one to turn the normally hydrophilic aluminum oxide surface hydrophobic.

A second method to avoid pinholes is to prepare aluminum oxide electrochemically, a process called anodization. Most anodization of aluminum today is done in sulfuric acid based electrolytes. However, sulfuric acid anodization leads to a highly porous aluminum which is a faulty dielectric. We have discovered that some older methods of so-called “hard anodization” employing boric acid solutions lead to good dielectric films. The boric acid solutions are doubly useful. First, in preliminary trials we did, the materials actually outperformed our standard silicon dioxide-on-silicon (in terms of capacitance, not robustness!), and second, the solution ingredients (3% boric acid and 0.03% borax) are perfectly safe to use. Anodization may be performed at room temperature at 100-250 V, and currents of 150 mA/cm² are fine. Processing a slightly elevated temperature may lead to better capacitance and less leakage. We expect this method to be more convenient than the use of other oxides (Kim, 2006; M. B. Gonzalez, A. Y. Wu, and P. M. Vilarinho, “Influence of solvents on the microstructure and dielectric properties of Ba0.5Sr0.5TiO3 thin films prepared by a diol-based sol-gel process,” Chemistry of Materials 18, 1737 (2006); K. Ueno, S. Abe, R. Onoki, and K. Saiki, “Anodization of electrolytically polished Ta surfaces for enhancement of carrier injection into organic field-effect transistors,” Journal of Applied Physics 98 (2005); L. A. Majewski and M. Grell, “Organic field-effect transistors with ultrathin modified gate insulator,” Synthetic Metals 151, 175 (2005)) and ultrathin polymer films (D. K. Hwang, K. Lee, J. H. Kim, S. Im, C. S. Kim, H. K. Baik, J. H. Park, and E. Kim, “Low-voltage high-mobilty pentacene thin-film transistors with polymer/high-k oxide double gate dielectrics,” Applied Physics Letters 88 (2006); S. Y. Yang, S. H. Kim, K. Shin, H. Jeon, and C. E. Park, “Low-voltage pentacene field effect transistors with ultrathin polymer gate dielectrics,” Applied Physics Letters 88 (2006); Y. Jang, D. H. Kim, Y. D. Park, 1. H. Cho, M. Hwang, and K. W. Cho, “Low-voltage and high-field-effect mobility organic transistors with a polymer insulator,” Applied Physics Letters 88 (2006); M. H. Yoon, H. Yan, A. Facchetti, and T. J. Marks, “Low-voltage organic field-effect transistors and inverters enabled by ultrathin cross-linked polymers as gate dielectrics,” Journal of The American Chemical Society 127, 10388 (2005) for educational purposes, though these alternatives have shown promise as candidates for manufacturable devices.

First, a suitable aluminum substrate can be provided. Pure aluminum plate is expensive; alloy plate is relatively inexpensive (˜$10/sq. ft. at 0.1″ thick), but making highly uniform anodized films on alloy is challenging because of the problem of “smut”, dust-like surface particles left on the surface from precipitates in the bulk of the material. Aluminum foil may be a good compromise, but it's mechanically fragile (and thus one could break any oxide formed quite easily), so we will need to glue the samples down first.

Second, we can assess and optimize capacitance quality. We have found capacitances on alloy plate of ˜1 nf/mm², which is good enough to make a gate dielectric, but we think that we can do better. We can also assess capacitance versus anodization time and voltage. The dielectric strength and resistance to parasitic conduction will be greatly improved by careful attention to electro-deposition parameters. Such improvement can be vital to producing a robust gate dielectric platform.

Third, we can assess the aluminum oxide films with and without phosphonate coatings. We can initially use octadecylphosphonic acid, a phosphonate molecule that binds to aluminum oxide and chemically presents a polyethylene-like surface. These will provide compatible surfaces for semiconductor growth and further resistance to electronic and ionic leakage currents.

Module #2. Electrowetting

The quality of the capacitive films on aluminum oxide should be dramatically testable by the observation of electrowetting, in which the contact angle of a droplet placed on the surface of a dielectric may be changed by the application of a voltage across the dielectric. The change in contact angle θ is given by the Lippman-Young Equation:

cos θ=cos θ₀+∉V²/(2dγ)=cos θ₀+V²C/(2γ)

where θ₀ is the contact angle without any voltage V, and γ is the surface tension of the liquid droplet. To see a good effect, one generally needs a hydrophobic surface to start, as the contact angle only decreases due to the V² effect. Because the applied voltage will be known (usually, one inserts a wire into the droplet from above as the counter electrode to the metal plate under the dielectric layer), changing the contact angle will allow students to directly measure the capacitance C without needing to probe the surface with wires that might break the dielectric layer.

Aluminum oxide is quite hydrophilic, so we can use phosphonate coatings or similar chemistry (e.g., dried Teflon emulsion) to render the surface hydrophobic.

One can also use a simple ocular contact angle goniometer using simple lenses, a light source, and a backdrop according to some embodiments of the current invention. These are simple devices which should be suitable for the classroom environment.

Module #3. Patterned Deposition of Conductors and Semiconductors

As discussed immediately below, we have had students prepare electronic devices by painting contacts composed of carbon ink. Device performance can be greatly enhanced when electrodes are applied gently and uniformly, with straight, closely spaced edges. Because of the relative destructiveness and edge roughness of the carbon ink painting method and the relatively low conductivity of the ink, device performance is limited and required voltages are higher than desired.

One can also use means of applying higher conductivity electrodes via more reproducible and geometrically controlled methods. One can optimize combinations of carbon and silver inks, which we have shown in some embodiments to be highly conductive and also to form effective contacts to organic films. Other kinds of inks can have gold and/or copper particles instead of, or in addition to, silver or carbon. Straight edges or knife edges can be used to enforce straight lines. We can deposit these inks through stencils, as liquids and as gentle aerosols, determining the practical resolution limits to stencil-mounted mask lines. We can also employ dry-transfer (A. C. Allen, E. Sunden, A. Cannon, S. Graham, and W. King, “Nanomaterial transfer using hot embossing for flexible electronic devices,” Applied Physics Letters 88 (2006); M. Ofuji, A. J. Lovinger, C. Kloc, T. Siegrist, A. 1. Maliakal, and H. B. Katz, “Organic semiconductor designed for lamination transfer between polymer films,” Chemistry of Materials 17, 5748; J. Park, S. O, Shim, and H. H. Lee, “Polymer thin-film transistors fabricated by dry transfer of polymer semiconductor,” Applied Physics Letters 86 (2005); G. Blanchet and J. Rogers, “Printing techniques for plastic electronics,” Journal of Imaging Science and Technology 47, 296 (2003); J. Zaumseil, K. W. Baldwin, and J. A. Rogers, “Contact resistance in organic transistors that use source and drain electrodes formed by soft contact lamination,” Journal of Applied Physics 93, 6117 (2003)) to allow students to apply pre-shaped conductive lines and semiconductor domains to devices from masters with patterned low surface energies, eliminating the variables arising from the need to steady a paint brush or pen. Fluoroalkylsilanes are readily available delamination promoters to ease the dry transfer process from substrates such as glass or poly(hydroxyethyl methacrylate).

Module #4. Field-Effect Transistors

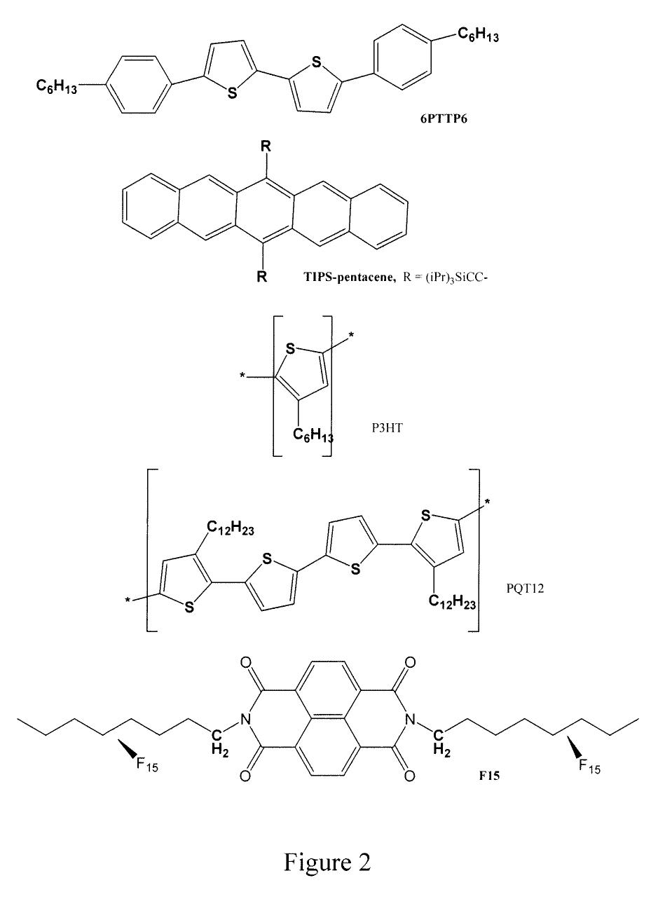

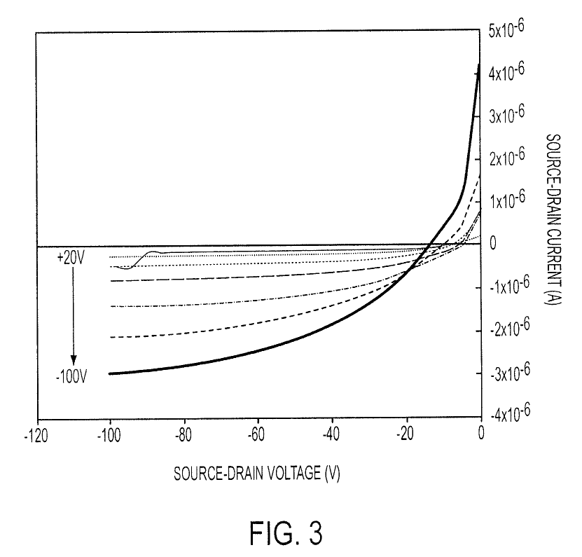

According to an embodiment of the current invention, every student in the course can have the experience of solution-depositing semiconductor films and source-drain electrodes to complete field-effect transistors by hand, obtaining and analyzing transistor current-voltage plots, and observing the microstructures of the device materials. Four organic and polymeric semiconductors have been used so far: 6PTTP6 (M. Mushrush, A. Facchetti, M. Lefenfeld, H. E. Katz, and T. 1. Marks, “Easily processable phenylene-thiophene-based organic field-effect transistors and solution fabricated nonvolatile transistor memory elements,” Journal of The American Chemical Society 125, 9414 (2003)) (5,5′-bis(4-hexylphenyl-2,2′-bithiophene), TIPS-pentacene (M. M. Payne, S. R. Parkin, J. E. Anthony, C. C. Kuo, and T. N. Jackson, “Organic field-effect transistors from solution-deposited functionalized acenes with mobilities as high as 1 cm(2)/V-s,” Journal of the American Chemical Society 127, 4986 (2005)) (6,13-bis(triisopropylsilylethynylpentacene), P3HT (regioregular poly(3-hexylthiophene) (Z. Bao, A. Dodabalapur, and A. J. Lovinger, “Soluble and processable regioregular poly(3-exylthiophene) for thin film field-effect transistor applications with high mobility,” Applied Physics Letters 69, 4108 (1996)) and PQT12 (B. S. Ong, Y. 1. Wu, P. Liu, and S. Gardner, “High-performance semiconducting polythiophenes for organic thin-film transistors,” Journal Of The American Chemical Society 126, 3378 (2004)) (poly(3,3′″-didodecyl-2,2′-5′,2″-5″,2′″-quaterthiophene), however, the broad concepts of the current invention are not limited to only these materials. All of these are majority hole transporters. Molecular structures of the semiconductors are shown in FIG. 2. Transistors can be made on substrates comprised of highly conductive silicon wafers with a thermal oxide as a gate dielectric. The semiconductor films can be bound inside a cm-square rectangle defined by painted lines of a fluorinated acrylate polymer, and can be thermally annealed by the students where necessary. Electrodes can be painted stripes of carbon ink. FIG. 3 shows a current-voltage plot obtained by a student according to this embodiment of the current invention. Every student in a class succeeded in obtaining such plots according to this embodiment of the current invention. Concepts such as capacitance per unit area and field-effect mobility are reinforced through this exercise, and hands-on experience with the most technologically important electronic component, the transistor, is obtained. Reliability and chemical sensitivity can be addressed by altering the pressures of organic vapors around the devices, an unprecedented approach in a classroom lab.

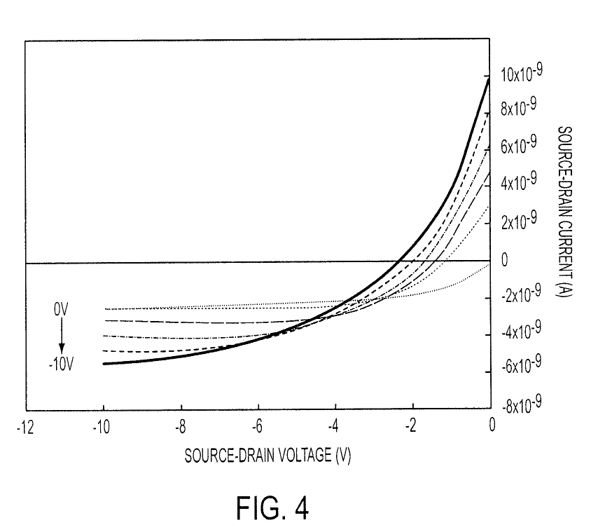

We have built transistors on an initial batch of boric acid anodized aluminum oxide gates and were able to reveal field effects in overlying the polymeric semiconductor films according to an embodiment of the current invention. FIG. 4 shows I-V plots of a device consisting of PQT12 deposited from a chlorinated solvent mixture inside a defined region of an alumina-aluminum surface, briefly annealed at 130 degrees C., and supplied with millimeter-width hand-painted source and drain electrodes according to an embodiment of the current invention. Though the drain currents are modest and leakage is relatively high, the voltages are kept at or below 10 V, and the field effect is clearly discernable. The capacitance times mobility per unit area (farads/volt second) is ca. 10⁻¹⁰, corresponding to a mobility of 10⁻³ cm²/Vs and an effective capacitance per unit area of 10⁻⁷ F/cm². We expect enormous refinements to be possible according to the current invention, especially after optimizing the dielectric layer growth, application of hydrophobic organic layers over the alumina, and tuning the polymer semiconductor architecture and processing to match the substrate (Baude, 2003; Klauk, 2007).

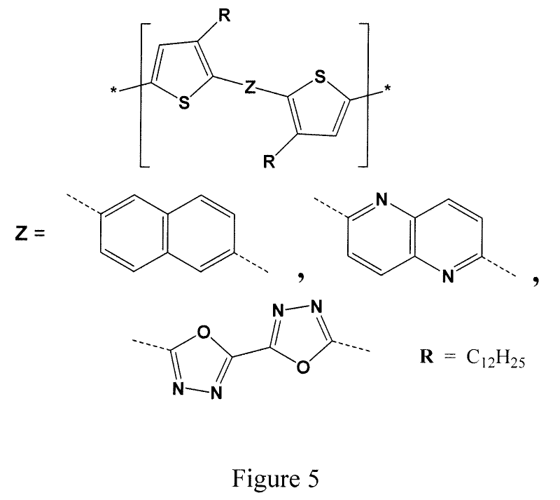

One can assess what semiconductors are most appropriate in a teaching context. To this end, we can first synthesize new polymeric semiconductors especially designed for educational purposes, as an extension to our ongoing polymer semiconductor synthesis program. Some examples are shown in FIG. 5. However, the broad concepts of the current invention are not limited to only these specific examples. In some cases, we found that even a small amount of naphthyl comonomer significantly reduced leakage current when incorporated into PQT12. One can also obtain or synthesize samples of higher mobility polymers being reported by the Merck and PARC groups, for example (I. McCulloch, M. Heeney, C. Bailey, K. Genevicius, 1. Macdonald, M. Shkunov, D. Sparrowe, S. Tierney, R. Wagner, W. M. Zhang, M. 1. Chabinyc, R. J. Kline, M. D. McGehee, and M. F. Toney, “Liquid-crystalline semiconducting polymers with high charge-carrier mobility,” Nature Materials 5, 328 (2006); Y. L. Wu, P. Liu, S. Gardner, and B. S. Ong, “Poly(3,3″-dialkylterthiophene)s: Room-temperature, solution-processed, high-mobilty semiconductors for organic thin-film transistors,” Chemistry of Materials 17, 221 (2005); Y. N. Li, Y. L. Wu, P. Liu, M. Birau, H. I. Pan, and B. S. Ong, “Poly(2,5-bis(2-thienyl)-3,6-dialkylthieno(3,2-b)thiophene)s-high-mobility semiconductors for thin-film transistors,” Advanced Materials 18, 3029). Crystalline molecular solids may also suited for use in embodiments of the current invention. One example of a molecular solid that we have found to be suitable in some embodiments is 6,13-bis(triispropylsilyl)ethynylpentacene. While some high mobilities are fortuitously obtained using molecular solids, the polymers seem to result in more reliably successful devices.

Hand-painted electrodes are not optimal. Currently, a paint of carbon in a solvent binder is being used, but we think better alternatives are possible in other embodiments of the current invention. For instance, mixtures of silver and carbon inks can be used to make higher conductivity leads to transistor devices. We expect that this electrode material can be used for the high width/length (W/L) transistors for inexpensive probing equipment to be usable.

A high priority and challenge here in organic semiconductor deposition is the use of relatively nontoxic solvents. While organic semiconductors in graduate and corporate research laboratories are often deposited from chlorinated solvents such as chloroform and chlorobenzene, these solvents are absolutely prohibited in U.S. high schools because of their toxicity. Even the relatively innocuous (but highly flammable) solvents toluene and acetone are accepted reluctantly, if at all, despite their inclusion in paints and polishes, for example. Thus, semiconducting polymers may need to be redesigned, possibly by incorporating hydroxylated side chains, so that they can be deposited from alcohols. Solution deposition of this oligomer from isopropanol is possible. In addition, semiconducting formulations such as aqueous colloids (C. Dionigi, P. Stoliar, W. Porzio, S. Destri, M. Cavallini, 1. Bilotti, A. Brillante, and F. Biscarni, “Field effect transistors with organic semiconductor layers assembled from aqueous colloidal nanocomposites,” Langmui 23, 2030 (2007)) can be used according to some embodiments of the current invention.

Module #5. Diodes

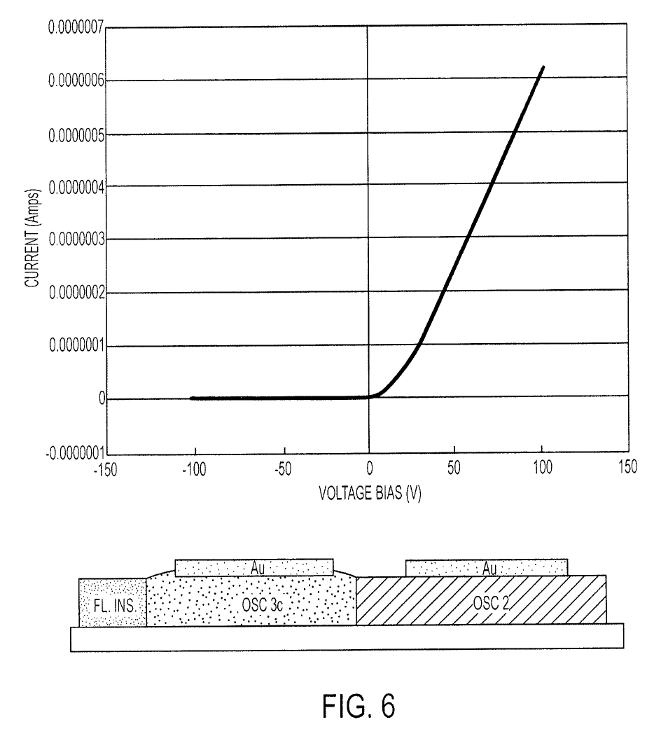

As an extension to the transistor activity, students have succeeded in fabricating a pn diode according to an embodiment of the current invention. The n (electron transporting) semiconductor was F15 (H. E. Katz, J. Johnson, A. J. Lovinger, and W. J. Li, “Naphthalenetetracarboxylic diimide-based n-channel transistor semiconductors: Structural variation and thiol-enhanced gold contacts,” Journal of The American Chemical Society 122, 7787 (2000); H. E. Katz, A. J. Lovinger, J. Johnson, C. Kloc, T. Siegrist, W. Li, Y. Y. Lin, and A. Dodabalapur, “A soluble and air-stable organic semiconductor with high electron mobility,” Nature 404,478 (2000)). This was pre-deposited by vacuum sublimation on a part of a substrate. The fluorinated side chains of F15 caused solutions of p-semiconductors to de-wet, so that the p films were bounded by the F15, creating a pn junction (FIG. 6). This device provided a dramatic illustration of the construction of a semiconductor rectifier.

Device Testing, Characterization and Evaluation

Transistors and diodes can be improved as material synthesis and processing innovations become available without departing from the general concepts of the current invention. Much of this optimization can be performed using equipment in classroom environments, such as in undergraduate and high school teaching laboratories.

Detailed characterization of gate dielectrics and device films can be performed by AFM, XRD, SEM, and semiconductor analyzer electronics. These experiments can enable the complete understanding of material quality in a technological sense, allowing for useful development of additional test methods and suitable device architectures for the lower-level educational environment.

One major challenge in the development of our modules has been to make and test devices in the absence of expensive equipment. The most challenging issue can be the substitution for the sophisticated and expensive semiconductor parameter analyzer by consumer-level electronic power and test equipment. This can demand that changes in resistance of micro-ohms or more (the scale of commonly available multimeters) be observable in response to voltages of ten volts or less (supplied by dry cell batteries or education-grade power supplies). The preliminary alumina transistor example according to an embodiment of the current invention showed a gate-induced current increase from 2.5 to 5.5 nA with drain voltage at 10 V, and W/L of approximately 2. This corresponds to a resistance change of two gigaohms. Thus, W/L of 2000 would provide a megaohm resistance change if the device were otherwise the same. Of course, scaling the device to W/L of 2000 and/or improving the materials so that W/L need not be as high as 2000 is not a simple task.

The invention has been described in detail with respect to various embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

We claim:

1. An educational kit, comprising:
electronic materials for the construction of an electronic component by a student in a classroom; and
an instruction packet that provides instructions for the construction of said electronic component by said student in said classroom using said electronic materials,
wherein said electronic materials for the construction of said electronic component are suitable for use by said student in said classroom without safety equipment and said instruction packet requires no more than common classroom equipment for the construction of said electronic component.

2. An educational kit according to claim 1, wherein said instruction packet further provides instructions for measuring a physical property of said electronic component by said student in said classroom.

3. An educational kit according to claim 1, wherein said electronic materials comprise at least one of an electrical conductor, an electrical insulator and a semiconductor.

4. An educational kit according to claim 1, wherein said electronic materials comprise aluminum oxide as a dielectric material for use in constructing said electronic component.

5. An educational kit according to claim 4, wherein said a dielectric material is hydrophobic aluminum oxide having a passivation layer.

6. An educational kit according to claim 4, wherein said electronic component is at least one of a capacitor and a transistor having said dielectric material in its composition.

7. An educational kit according to claim 1, wherein said electronic materials comprise a solution-processable semiconductor to be incorporated into said electronic component to be constructed.

8. An educational kit according to claim 7, wherein said solution-processable semiconductor is an organic semiconductor.

9. An educational kit according to claim 1, wherein said electronic materials comprise a semiconductor to be incorporated into said electronic component to be constructed, said semiconductor being selected from the group of semiconductors consisting of 6PTTP6, TIPS-pentacene, P3HT, and PQT12.

10. An educational kit according to claim 1, wherein said electronic materials comprise a solution-processable electrical conducting material.

11. An educational kit according to claim 10, wherein said solution-processable electrical conducting material is at lest one of a liquid, a dispersion or a suspension that can be deposited by at least one of a spray, stamping or painting process.

12. An educational kit according to claim 1, wherein said materials comprise materials for the construction of a plurality of electronic components and said instruction packet provides instructions for the construction of said plurality electronic components by said student in said classroom.

13. An educational kit according to claim 12, wherein said plurality of electronic components comprises a plurality of different types of electronic components.

14. An educational kit according to claim 13, wherein said plurality of different types of electronic components are selected from the group of electronic components consisting of a capacitor, a diode, and a transistor.

15. An educational kit according to claim 1, wherein said electronic component is selected from the group of electronic components consisting of a capacitor, a diode and a transistor.

16. An educational kit according to claim 1, further comprising tools for the production of at least one of patterned conductors, patterned semiconductors or patterned dielectrics.

17. An educational kit according to claim 16, wherein said tools comprise a paintbrush.

18. An educational kit according to claim 16, wherein said tools comprise a stencil.

19. An educational kit according to claim 1, further comprising a substrate upon which at least some of said electronic materials will be deposited to construct the electronic component.

20. A method of teaching, comprising:
providing a student with an educational kit that provides electronic materials and an instruction packet to construct at least one electronic component from said materials provided in said kit according to instructions provided in said instruction packet;
requiring said student to construct said at least one electronic component, to perform device-characterization tests on said electronic component, and to prepare a written report of results of said constructing and characterization of said electronic component; and
evaluating said written report,
wherein said electronic materials for the construction of said electronic component are suitable for use by said student in said classroom without safety equipment and said instruction packet requires no more than common classroom equipment for the construction of said electronic component.
